(19) United States
(12) Patent Application Publication
(10) Pub. No.: US 2005/0155292 A1
(43) Pub. Date: Jul. 21, 2005

(54) Seal able to provide a sealing action between a fixed part and a part which can be opened

(76) Inventors: Paolo Cittadini, Luvinate (IT); Marco De Giorgi, Varese (IT)

Correspondence Address: Abelman Frayne & Schwab, 150 East 42nd Street, New York, NY, 10017-5612, US

(21) Appl. No.: 10/503,149

(22) PCT Filed: Jan. 13, 2003
(86) PCT No.: PCT/EP03/01077

(30) Foreign Application Priority Data
Jan. 28, 2002 (IT) MI2002A000140

(51) Int. Cl. E06B 7/16

(52) U.S. Cl. 49/490.1

(57) ABSTRACT

A seal has a sealing action between a fixed part and a part which can be opened, in particular between the body and the door of a vehicle, of the type having a profiled element for fixing to the parts and a portion consisting of material which is deformable as a result of compression so as to provide operationally the sealing action, including at least two elements of magnetic material having surfaces with the same polarity are arranged in the region of the deformable portion, in a position facing each other.

### CROSS-REFERENCE TO RELATED APPLICATIONS

This application is a 371 of PCT/EP03/01077, filed on Jan. 13, 2003.

### BACKGROUND OF THE INVENTION

1. Field of the Invention

The present invention relates to a seal able in particular to provide a sealing action between a fixed part and a part which can be opened, for example between the body and the door of a vehicle.

2. Description of the Related Art

The Applicants are proprietors of various patents relating to this kind of seal, such as for example the patent EP 519545 relating in particular to extensible seals of the magnetic type.

Also known are seals for doors of motor vehicles generally consisting of a rigid support and a compressible sealing element having a tubular or pear-shaped cross-section and bonded together by means of coextrusion or in some other way. The rigid support (known as a “snap-on” part) has the function of fixing the seal so that the sealing element is operationally positioned between the adjacent surfaces of the door and the body of the motor vehicle, sealing completely, in the closed position, the existing space between the two surfaces under compression as result of crushing between door and body. In this connection U.S. Pat. No. 4,030,245 and U.S. Pat. No. 5,355,628 may be cited.

The tolerances of the motor vehicle assembly plants, however, are unable to guarantee in all cases the sealing action of the seal, since the distance between door and body along the perimeter of the door may be subject to notable variations (even in the region of 20%).

The attempt to overcome this drawback by increasing the dimensions of the compressible element of the seal would have the undesirable effect of increasing the force necessary for closing the door beyond acceptable values.

The limited effectiveness of this known type of seal is evident in particular during high-speed travel of the vehicle, with an increase in the noisiness caused by the infiltration of air in the case where the pressure of the air exceeds the elastic thrust of the rubber sealing element.

This capacity for elastic reaction to the pressure of the air acting on the vehicle during travel varies owing to the effect of the variation with the temperature of the elastic properties of the polymer material from which the seal is made and also deteriorates over time as a result of the permanent deformation under compression which causes aging and wear of the seal. This phenomenon is represented by the compression set value of the material.

This problem is accentuated in the case of use of thermoplastic elastomers, which are preferable, because of their recyclable nature, to cross-linked rubbers, but are characterized by high compression set values. A possible solution to these limitations of known seals consists in the use of seals having a generally complex form and comprising magnetic elements which are present both in the form of inserts and coextruded and which face each other upon bearing contact of the seal, producing the sealing action of the latter.

In order to perform their function, these magnetic elements of the seals must come into contact with a wall of ferromagnetic material or, alternatively, in the case where non-ferrous materials such as aluminum or plastic materials are used, it is necessary to provide inserts consisting of ferromagnetic metal or magnets on the wall, which perform the function of an opposing pole.

The patent U.S. Pat. No. 6,273,433 (EP 1031450) describes the application, by means of extrusion, of a thin layer of rubbery magnetic compound onto the external surface of the compressible tubular element of a seal of the conventional type or by means of direct coextrusion; magnetization is performed in-line.

The patent JP 4201716 also describes conventionally designed seals having the magnetic element coextruded, but in this case it is optionally envisaged providing a second magnetic element of opposite polarity, having the function of improving the effectiveness of the system for fastening the seal to the bodywork. In this latter case, the presence of two magnets of opposing polarity could however give rise to the problem of deformation towards the inside of the tubular element as a result of the magnetic force of attraction of the magnets.

The presence of magnetic elements on the visible surface of the seal, which are characterized by the typical color (dark red) of ferrite present in a high concentration, also constitutes a limitation of an aesthetic nature especially in the case of light-colored seals.

Both the examples cited, however, are not applicable in the case of use of non-ferromagnetic materials for the construction of the body of the motor vehicle or for other applications.

A problem which is often insurmountable is that of having to form three-dimensional folds of the magnetic seals in order to follow the geometry of the doors: the technical solutions to this problem are complex and require the use of high-energy magnetic powders, which make use thereof inconvenient.

### BRIEF SUMMARY OF THE INVENTION

The object of the present invention is to find an effective solution to the set of technical problems described above.

In order to achieve this object, the present invention proposes a seal able to provide a sealing action between a fixed part and a part which can be opened, in particular between the body and the door of a vehicle, of the type comprising a profiled element for fixing to the parts and a portion consisting of material which is deformable under compression so as to provide operationally the sealing action, characterized in that at least two elements of magnetic material having surfaces with the same polarity are arranged in the region of the deformable portion, in a position facing each other so as to exert a repulsive force between them.

### BRIEF DESCRIPTION OF THE SEVERAL VIEWS OF THE DRAWINGS

In order to understand better characteristic features and advantages of the invention, a non-limiting example of embodiment thereof is described below with reference to the figures of the accompanying drawings.

FIG. 1 shows a cross-sectional view of a seal according to the invention.

FIGS. 2 and 3 show similar cross-sectional views of the same seal operationally mounted on a vehicle, at two different points along the line of closure of a door and the corresponding body, respectively on the side where the door is hinged with the body and on the opposite side.

FIG. 4 shows a cross-sectional view of a variant of the invention.

### DETAILED DESCRIPTION OF THE INVENTION

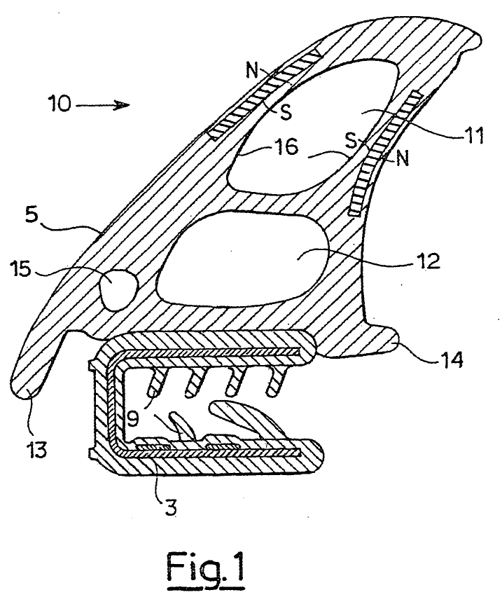

With reference to FIGS. 1, 2 and 3, a seal 10 according to the invention comprises a profiled element 4 consisting of a snap-on part with a metal core 3 and a C-shaped cross-section. This profiled element 4 is fixed along the whole periphery of a rim 8 surrounding an opening in the body 1 of the motor vehicle where it co-operates with a door 2. The profiled element 4 is fitted and fixed onto the rim by means of the pressure exerted by the flanges of the metal core 3, the adherence being completed by the action of the deformable sawtooth lugs 9 which act elastically on the rim. A magnetic element may be inserted into this snap-on part in order to improve the sealing action on the body.

On the side of the snap-on part which is operationally directed towards the door 2, there extends the portion 5 of the seal which performs the sealing function and is made of elastically deformable material.

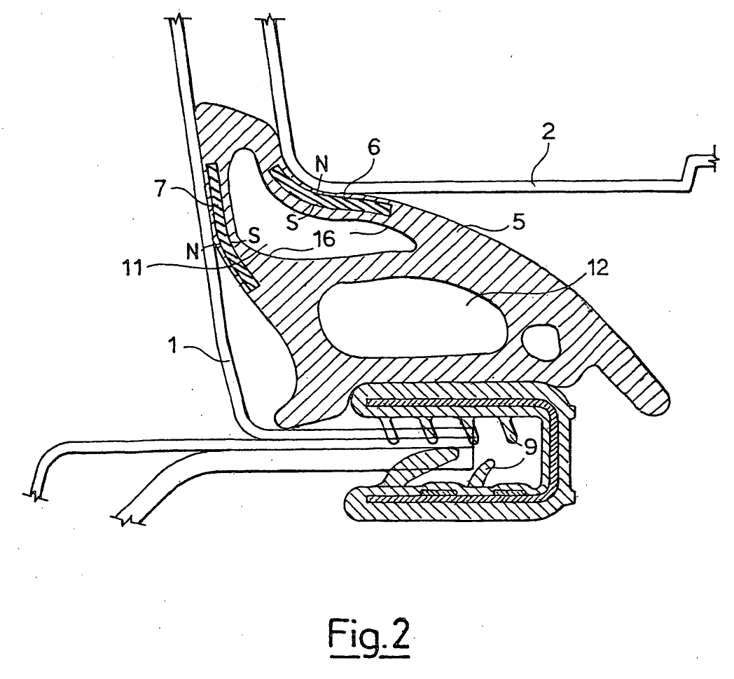

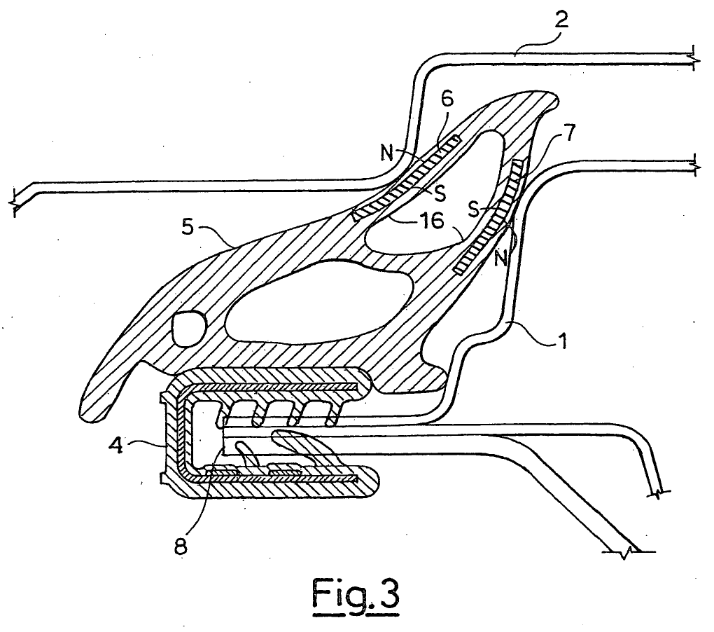

The shape of the portion 5 may vary greatly: in the case of the example shown in the drawings, it consists of an approximately triangular section, comprising a pair of tubular chambers 11, 12 which accentuate the deformability characteristic during the operative phase where sealing is achieved by means of compression as a result of squashing between the fixed part and the part which can be opened, as shown in FIGS. 2 and 3. The presence of an additional tubular chamber with a smaller volume is indicated by 15.

In particular, FIG. 2 shows the seal in the operative closed position of the door 2 on the side where the latter is hinged on the body 1, while FIG. 3 shows the same seal in the operative closed position on the other side, i.e. the side where generally the opening handle of the door 2 is positioned.

The cross-section of the portion 5 terminates at the two ends of the base of the triangle in a pair of lips 13 and 14 having an additional sealing function on the body 1. As can be seen in FIGS. 2 and 3, on the hinge side of the door, the lip 13 is deformed and acts as a seal, while on the opposite side (FIG. 3) the lip 14 is deformed and acts as a seal.

As can again be seen in FIGS. 2 and 3, the part of the seal responsible for the main sealing action between body and door is that where the tubular chamber 11 is provided. On the sides of the latter there are arranged, coextruded in the portion 5 in a mutually facing position, two strips 6 and 7 of magnetic material with the same polarity, namely with the same poles arranged opposite each other. In the figures, this is schematically represented by the symbols S/S on the surfaces of the strips facing the chamber 11 and by the symbols N/N on the opposite surfaces, with reference to the polarities involved.

Therefore, a repulsive force which is caused by the opposite magnetic field and which opposes the compressive force exerted on the portion 5, in particular on the tubular chamber 11, in the closed position of the door 2 against the body 1 of the vehicle, is generated between the two magnetic elements 6 and 7 kept facing each other with the same opposing poles.

This force is used according to the invention to oppose the variation, in particular the deterioration, of the elastic properties of the material forming the seal both owing to the variations in temperature and owing to the permanent deformations which arise under compression over time owing to aging in the case of small thicknesses and thermoplastic materials, thus replacing the elastic reaction of the material. The repulsive force generated in this way acts at all times, both in the operative closed position and in the rest condition, favoring restoration of the original shape and maintaining the closing force.

For the seal according to the invention, it is possible to use materials preferably chosen from among vulcanized rubbers, such as those based on NBR and EPDM rubbers, thermoplastic rubbers such as those based on copolymers SBS, SIS and terpolymers SEBS and SEPS and those belonging to the class of dynamically vulcanized thermoplastic elastomers, based on mixtures of PP/EPDM, known commercially as Santoprene, and also compounds of PVC suitably reinforced with filler. Thermoplastic rubbery materials are preferred because of their recyclable nature.

The elements consisting of magnetic material are preferably, but not exclusively, strips of plastic magnetic material, such as plastic ferrite, which are coextruded with the material which forms the seal.

Numerous variants of the invention may be realized with respect to that illustrated by way of example above, in particular as regards the geometry of the deformable portion of the seal and the arrangement of the elements or the strips with magnetic properties necessary for producing the repulsive force indispensable for the objects of the invention.

The magnetic elements are preferably coextruded strips of plastic ferrite which are inserted inside the deformable portion of the seal, embedded therein, as shown in the abovementioned examples, thus avoiding those limitations of an aesthetic nature discussed above since the color of the ferrite is not visible. However, according to the present invention, they be arranged in accordance with different embodiments, both as regards their position in the deformable portion of the seal, and as regards their shape, dimensions and location. For example, they may have a form other than that of a strip, may be inserts which are not coextruded, but inserted in special seats in the seal, may not be embedded in the seal, but be situated on the internal surface of the deformed tubular chamber (reference number 16 with respect to the tubular chamber 11 in FIGS. 1, 2 and 3 of the accompanying drawings) so as to increase the mutual magnetic repulsive effect, or may be a plurality of elements arranged as required in any zone where there is a greater risk of permanent deformations, provided this is in keeping with the fundamental teaching of the invention whereby they are able to create in these zones of greater deformability a repulsive magnetic field such as to oppose those deformation effects which cause aging of the seal and deterioration of its sealing properties.

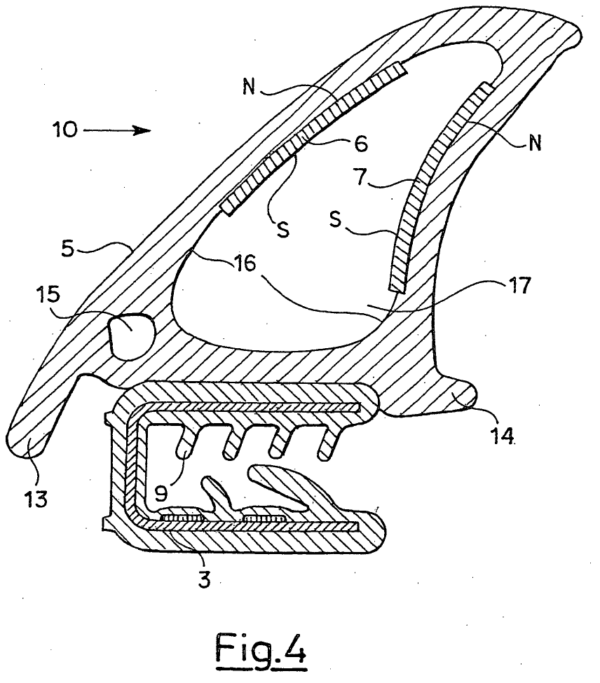

For example, in the variant shown in FIG. 4, the elements 6, 7 of magnetic material are in fact arranged in a mutually facing position in the deformable portion 5 of the seal along the internal surface 16 of a single tubular chamber 17. They are coextruded with the portion 5 so as to be situated on the surface 16 without being embedded therein, thus facing each other without the presence of material in between. In this way the repulsive magnetic force which is produced between the surfaces S/S of the opposite elements 6 and 7 is increased with respect to that of the embodiment according to FIG. 1.

The desired magnetic characteristics are preferably obtained by means of in-line magnetization in accordance with the techniques commonly used at an industrial level, for example by means of the magnetization with electromagnets or rare-earth magnets.

Moreover the choice of the most appropriate type of magnetic powder, as well as its quantity, results in a wider range of magnetic properties for the elements or strips of magnetic material according to the invention, allowing the magnetic repulsive force to be adjusted in each case depending on the form or design of the seal and the properties of the materials used.

The percentage by weight of magnetic powder contained in the powder plus polymer binder mixture, which generally usefully consists of low-hardness thermoplastic elastomers, may vary preferably between 40% and 93%.

Finally, it is understood that the abovementioned part which can be opened in a vehicle may be the hood, the engine compartment, a sliding door, the trunk, and the like.

The seal according to the invention is likewise suitable for applications in fields other than the motor vehicle sector.

1. Seal able to provide a sealing action between a fixed part (1) and a part (3) which can be opened, in particular between the body and the door of a vehicle, the seal being of the type comprising:
a profiled element (4) for fixing to said parts; and
a portion (5) consisting of material which is deformable under compression so as to provide operationally said sealing action, wherein at least two elements of magnetic material having surfaces with the same polarity are arranged in the region of said deformable portion (5), in a position facing each other so as to exert a repulsive force between them.

2. Seal according to claim 1, wherein the elements (6, 7) of magnetic material having surfaces with the same polarity are arranged on the sides of a tubular chamber (11) which is operationally intended to be compressed between said fixed part (1) and part (3) which can be opened in the closed position of the latter.

3. Seal according to claim 1, wherein the elements (6, 7) of magnetic material are coextruded with said portion (5) of the seal.

4. Seal according to claim 3, wherein the elements (6, 7) of magnetic material are in the form of coextruded strips or laminae.

5. Seal according to claim 1, wherein the elements (6, 7) of magnetic material are arranged as inserts in seats formed in a mutually facing position in said portion (5).

6. Seal according to claim 2, wherein the elements (6, 7) of magnetic material are arranged embedded in said deformable portion (5) of the seal in the vicinity of the surface of said tubular chamber (11).

7. Seal according to claim 2, wherein the elements (6, 7) of magnetic material are arranged in a mutually facing position in said deformable portion (5) of the seal in the region of the internal surface (16) of said tubular chamber (11).

8. Seal according to claim 2, wherein the deformable portion (5) comprises additional tubular chambers (12).

9. Seal according to claim 1, wherein the deformable portion (5) includes sealing lips (13, 14) which operationally are deformed, bearing against the surface of at least one of said parts (1) or (3).

10. (canceled)
